(19) United States
(12) Patent Application Publication
(10) Pub. No.: US 2025/0332507 A1
(43) Pub. Date: Oct. 30, 2025

(54) OPERATION CONTROL METHOD AND APPARATUS, DEVICE, STORAGE MEDIUM, AND PROGRAM PRODUCT

(71) Applicant: Tencent Technology (Shenzhen) Company Limited, Shenzhen (CN)

(72) Inventors: Bingxi ZHANG, Shenzhen (CN); Fang GAO, Shenzhen (CN); Yingcai GUO, Shenzhen (CN); Weiqing YANG, Shenzhen (CN); Jun ZHANG, Shenzhen (CN)

(21) Appl. No.: 19/264,700

(22) Filed: Jul. 9, 2025

Related U.S. Application Data
(63) Continuation of application No. PCT/CN2024/084338, filed on Mar. 28, 2024.

(30) Foreign Application Priority Data
May 25, 2023 (CN) 202310603344.0

(51) Int. Cl. A63F 13/497

(52) U.S. Cl. CPC A63F 13/497

(57) ABSTRACT

This application discloses an operation control method performed by a computer device. The method includes: displaying a first game picture, the first game picture including a virtual object located in a virtual environment and corresponding to a first state of a game; controlling the virtual object to play the game in the virtual environment from the first state to a second state; in response to a trigger operation of a rollback function, controlling the game to roll back a game state of the virtual object in the virtual environment from the second state to a historical state corresponding to a second game picture of the game; and controlling the virtual object to replay the game starting from the historical state. The method makes the operation control manners for the game more diversified, providing higher flexibility in operation control.

### CROSS-REFERENCE TO RELATED APPLICATIONS

This application is a continuation application of PCT Patent Application No. PCT/CN2024/084338, entitled “OPERATION CONTROL METHOD AND APPARATUS, DEVICE, STORAGE MEDIUM, AND PROGRAM PRODUCT” filed on Mar. 28, 2024, which claims priority to Chinese Patent Application No. 2023106033440, entitled “OPERATION CONTROL METHOD AND APPARATUS, DEVICE, AND COMPUTER-READABLE STORAGE MEDIUM” filed with the China National Intellectual Property Administration on May 25, 2023, both of which are incorporated herein by reference in their entirety.

### FIELD OF THE TECHNOLOGY

Embodiments of this application relate to the field of computer technologies, and in particular, to operation control.

### BACKGROUND OF THE DISCLOSURE

With the continuous development of computer technologies, video games have become a common form of entertainment in people's daily lives. Multiplayer online battle arena (MOBA) games are one of video games.

In multiplayer online battle arena games, the flexibility and diversity of operation control have become important factors in attracting players. Therefore, it is necessary to provide an operation control method, to improve the flexibility and diversity of operation control.

### SUMMARY

Embodiments of this application provide an operation control method and apparatus, a device, a storage medium, and a program product. The technical solutions are as follows:

According to an aspect, an embodiment of this application provides an operation control method performed by a computer device. The method includes:
displaying a first game picture, the first game picture including a virtual object located in a virtual environment and corresponding to a first state of a game;
controlling the virtual object to play the game in the virtual environment from the first state to a second state;
in response to a trigger operation of a rollback function, controlling the game to roll back a game state of the virtual object in the virtual environment from the second state to a historical state corresponding to a second game picture of the game; and
controlling the virtual object to replay the game starting from the historical state.

According to another aspect, an embodiment of this application provides a computer device. The computer device includes a processor and a memory. The memory has a computer program stored therein, and the computer program is loaded and executed by the processor to cause the computer device to implement the operation control method described above.

According to another aspect, a non-transitory computer-readable storage medium is further provided. The computer-readable storage medium has a computer program stored therein. The computer program is loaded and executed by a processor, to cause a computer to implement the operation control method described above.

According to another aspect, a computer program product is further provided. The computer program product has a computer program stored therein. The computer program is loaded and executed by a processor, to cause a computer device to implement the operation control method according to any one of the foregoing.

The technical solutions provided in the embodiments of this application bring at least the following beneficial effects:

In the technical solutions provided in the embodiments of this application, when the rollback function is triggered, the second game picture is displayed. The game state of the virtual object located in the virtual environment and included in the second game picture is the historical state, to control the virtual object to replay the game starting from the historical state. According to the method, when the object state of a player in the first game picture fails to meet expectations, for example, the player is accidentally hit, or triggers an incorrect operation in the first game picture, the player may use the rollback function to roll back the game to the second game picture prior to the first game picture, to continue to play the game with the object state in the second game picture. This game rollback manner enables the player to quickly and conveniently roll back the game progress during the game, making the operation control manners for the game by the player more diversified, thereby improving the flexibility of operation control for the game by the player, and improving the gaming experience of the player to some extent.

### BRIEF DESCRIPTION OF THE DRAWINGS

FIG. 1 is a schematic diagram of an implementation environment of an operation control method according to an embodiment of this application.

FIG. 2 is a flowchart of an operation control method according to an embodiment of this application.

FIG. 3 is a schematic diagram of displaying a start page according to an embodiment of this application.

FIG. 4 is a schematic diagram of displaying a first game picture according to an embodiment of this application.

FIG. 5 is another schematic diagram of displaying a first game picture according to an embodiment of this application.

FIG. 6 is another schematic diagram of displaying a first game picture according to an embodiment of this application.

FIG. 7 is another schematic diagram of displaying a first game picture according to an embodiment of this application.

FIG. 8 is a schematic diagram of a process of obtaining an object state of a virtual object included in a second game picture according to an embodiment of this application.

FIG. 9 is another schematic diagram of a process of obtaining an object state of a virtual object included in a second game picture according to an embodiment of this application.

FIG. 10 is another schematic diagram of a process of obtaining an object state of a virtual object included in a second game picture according to an embodiment of this application.

FIG. 11 is a schematic diagram of displaying a second game picture according to an embodiment of this application.

FIG. 12 is a flowchart of an operation control method according to an embodiment of this application.

FIG. 13 is a schematic structural diagram of an operation control apparatus according to an embodiment of this application.

FIG. 14 is a schematic structural diagram of a terminal device according to an embodiment of this application.

FIG. 15 is a schematic structural diagram of a server according to an embodiment of this application.

### DESCRIPTION OF EMBODIMENTS

To make the objectives, technical solutions, and advantages of this application clearer, the following further describes implementations of this application in detail with reference to the accompanying drawings.

Abbreviations or key terms involved in the embodiments of this application are defined.

Virtual object: The virtual object is a movable object in a virtual scene. The movable object may be a virtual character, a virtual animal, an anime character, or the like. A target object may control the virtual object by using a peripheral component or in a manner of clicking/tapping and touching a display screen. Each virtual object has its own shape and volume in the virtual scene, and occupies some space in the virtual scene. For example, when the virtual scene is a three-dimensional virtual scene, the virtual object is a three-dimensional model created based on a skeletal animation technology.

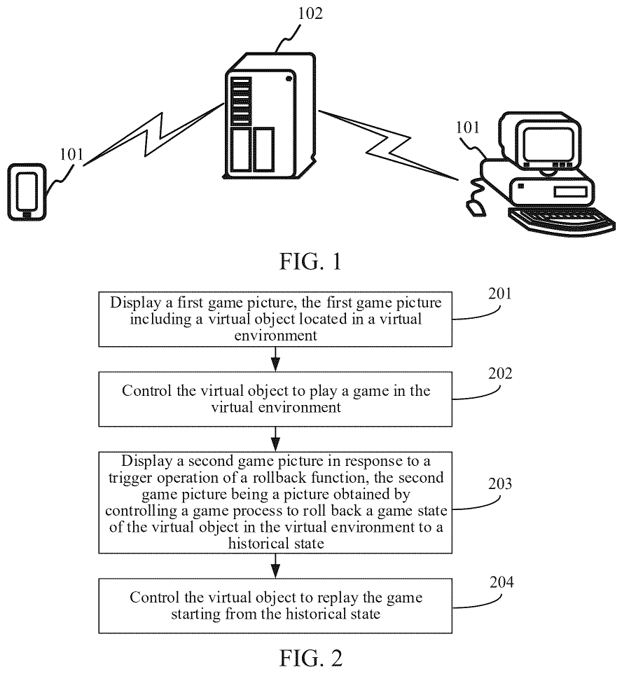

FIG. 1 is a schematic diagram of an implementation environment of an operation control method according to an embodiment of this application. As shown in FIG. 1, the implementation environment includes: a terminal device 101 and a server 102.

An application that can provide a game picture is installed and run in the terminal device 101. The terminal device 101 is configured to perform the operation control method provided in the embodiments of this application.

A type of the application that can provide a game picture is not limited in the embodiments of this application. For example, the application that can provide a game picture is a game application, for example, a third-person shooting (TPS) game, a first-person shooting (FPS) game, a multiplayer online battle arena (MOBA) game, a multiplayer shooting survival game, or a massive multiplayer online role-playing game (MMO RPG). In an exemplary embodiment, the game application involved in the embodiments of this application is a game application based on frame synchronization. In other words, the operation control method provided in the embodiments of this application is applicable to a game application based on frame synchronization.

Certainly, in addition to the game application, the application that can provide a game picture may alternatively be another type of application, for example, a virtual reality (VR) application, an augmented reality (AR) application, a three-dimensional map, a scene simulation program, a social application, or an interactive entertainment application.

The server 102 is configured to provide a backend service for the application that can provide a game picture installed in the terminal device 101. In a possible implementation, the server 102 undertakes primary computing work, and the terminal device 101 undertakes secondary computing work. Alternatively, the server 102 undertakes secondary computing work, and the terminal device 101 undertakes primary computing work. Alternatively, a distributed computing architecture is used between the server 101 and the server 102 to perform collaborative computing.

The terminal device 101 is any electronic device product that can perform human-computer interaction with a user in one or more manners such as a keyboard, a touchpad, a touch screen, a remote control, voice interaction, or a handwriting device, for example, a personal computer (PC), a mobile phone, a smart phone, a personal digital assistant (PDA), a wearable device, a pocket PC (PPC), a tablet computer, a smart vehicle computer, a smart television, or a smart speaker. The server 102 may be one server, a server cluster including a plurality of server units, or a cloud computing service center. A communication connection is established between the terminal device 101 and the server 102 via a wired or wireless network.

A person skilled in the art can understand that the terminal device 101 and the server 102 are merely examples for description. Other existing or hereafter possible terminal devices or servers, if applicable to this application, also fall within the protection scope of this application, and are incorporated herein by reference.

An embodiment of this application provides an operation control method. The method is applicable to the implementation environment shown in FIG. 1. Using a flowchart of an operation control method according to an embodiment of this application shown in FIG. 2 as an example, the method may be performed by the terminal device 101 in FIG. 1. As shown in FIG. 2, the method includes the following operation 201 to operation 204.

Operation 201: Display a first game picture, the first game picture including a virtual object located in a virtual environment.

In an exemplary embodiment of this application, a game application is installed and run in the terminal device. The game application may be an application that needs to be downloaded and installed, or may be an embedded program that is run in dependence on a host program, for example, a mini program. This is not limited in this embodiment of this application. The embedded program is an application that is developed based on a programming language and that is run in dependence on a host program. The embedded program does not need to be downloaded and installed, and can be run only by being dynamically loaded in the host program. A user may find an embedded program that the user needs in a manner of searching, scanning, or the like. The embedded program can be used upon click/tap, and an internal memory of the terminal device is not occupied after the embedded program is used and shut down. This is convenient. The game application may be a first-person shooting application, a third-person shooting application, a massive multiplayer online role-playing application, or another type of application. A type of the game application is not limited in this embodiment of this application.

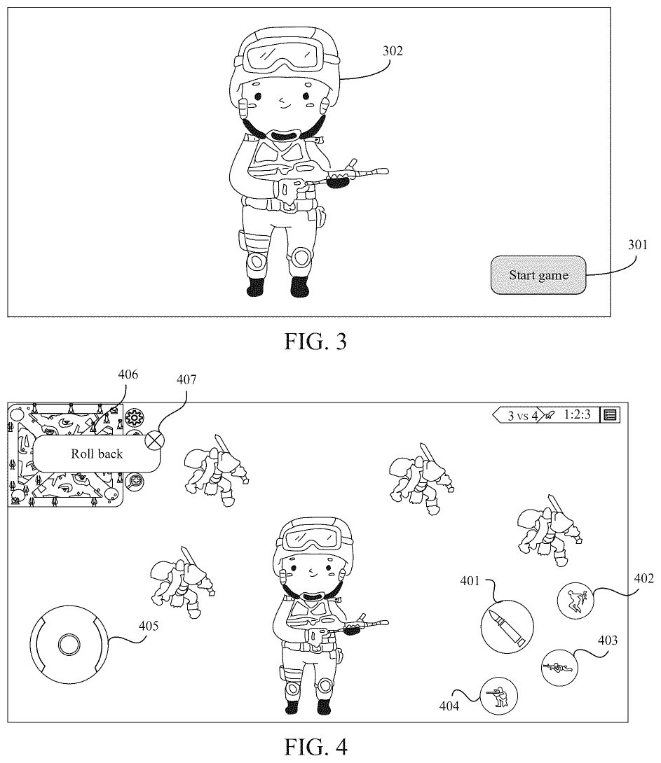

Related information of the game application is displayed on a display interface of the terminal device. The related information of the game application may be an icon of the game application, a name of the game application, other information that can identify the game application, or the like. This is not limited in this embodiment of this application. When the user wants to start the game application, the user selects the related information of the game application, and the terminal device receives a selection operation for the game related information, and displays a start page. A start control is displayed on the start page. FIG. 3 is a schematic diagram of displaying a start page according to an embodiment of this application. A start control 301 is displayed on the start page.

When the user selects the start control, the terminal device receives a selection operation for the start control, starts a round of game, and displays a first game picture. The first game picture includes a virtual object located in a virtual environment. In subsequent embodiments, a round of game of the game application is used as an example for description, and the involved first, second, third, fourth game pictures, and the like all belong to game pictures in the same round of game.

The virtual environment is a game scene displayed by the game application after the terminal device runs the game application. The virtual environment includes a virtual object provided by the game application, including a virtual object controlled by at least one player (for example, a use object of the terminal device), and may further include another environment object in the game scene, for example, a ground, a background, or a non-player object.

FIG. 4 is a schematic diagram of displaying a first game picture according to an embodiment of this application. A virtual environment and a virtual object located in the virtual environment are displayed in the first game picture.

In a possible implementation, the virtual object displayed in the first game picture may include a virtual object controlled by a use object (for example, the user) of the terminal device, and may further include a virtual object controlled by another player. The another player may be an object of the same battle team as the use object, or may be an object of a different battle team from the use object. This is not limited in this embodiment of this application.

The user selecting the start control may refer to the user clicking/tapping the start control, the user double-clicking/tapping the start control, or the user selecting the start control in another manner. This is not limited in this embodiment of this application. The user selecting the related information of the game application may refer to the user clicking/tapping the related information of the game application, the user selecting the related information of the application through a voice, or another manner. A manner of selecting the related information of the game application is not limited in this embodiment of this application.

In some embodiments, other information may further be displayed on the start page. For example, the virtual object controlled by the user may further be displayed on the start page. As shown in FIG. 3, 302 is a virtual object controlled by the user.

Operation 202: Control the virtual object to play a game in the virtual environment.

In a possible implementation, another control is further displayed in the first game picture. For example, a virtual control configured to control a change of an object state of the virtual object may be further displayed in the first game picture, for example, a fire control, a jump control, a prone control, a crouch control, and a direction control. The fire control is configured to fire a virtual resource by using a virtual item, the jump control is configured to instruct the virtual object controlled by the use object to jump, the prone control is configured to instruct the virtual object controlled by the use object to prone, the crouch control is configured to instruct the virtual object controlled by the use object to crouch, and the direction control is configured to change a movement direction of the virtual object controlled by the use object. As shown in FIG. 4, a control 401 is a fire control, a control 402 is a jump control, a control 403 is a prone control, a control 404 is a crouch control, and a control 405 is a direction control.

In some embodiments, the virtual object is controlled, by using at least one of the fire control, the jump control, the prone control, the crouch control, or the direction control, to play the game in the virtual environment. Certainly, another control may be further displayed in the first game picture. This is not limited in this embodiment of this application.

Operation 203: Display a second game picture in response to a trigger operation of a rollback function, the second game picture being a picture obtained by controlling a game process to roll back a game state of the virtual object in the virtual environment to a historical state.

In some embodiments, the rollback function is a function of rolling back a game state of a virtual object in a virtual environment, for example, rolling back from a first game picture to a previous second game picture.

In a possible implementation, a difference between frame numbers of the first game picture and the second game picture in the game satisfies a frame number corresponding to a reference duration, and the reference duration is a duration corresponding to the rollback function. In other words, the rollback function may be rapid rollback corresponding to a fixed rollback duration, for example, 5 seconds or 10 seconds, to return the round of game from a game progress at a current game moment to a game progress at a game moment 5 seconds or 10 seconds ago.

The terminal device may determine a frame number corresponding to the duration based on a running frame rate of the game application, and then roll back the round of game based on the frame number. The duration may be a preset fixed duration, may vary for different types of game battles, or may change based on adjustment of the user. This is not limited in this application.

The rollback function may be triggered by a voice instruction, or may be triggered in response to a trigger operation. For example, a rollback control may be further displayed in the first game picture. For example, a control 406 in FIG. 4 is a rollback control. In response to a trigger operation for the rollback control, triggering of the rollback function is determined. Alternatively, triggering of the rollback function is determined in response to a trigger operation for a volume up control of the terminal device, or, triggering of the rollback function is determined in response to a trigger operation for a volume down control of the terminal device.

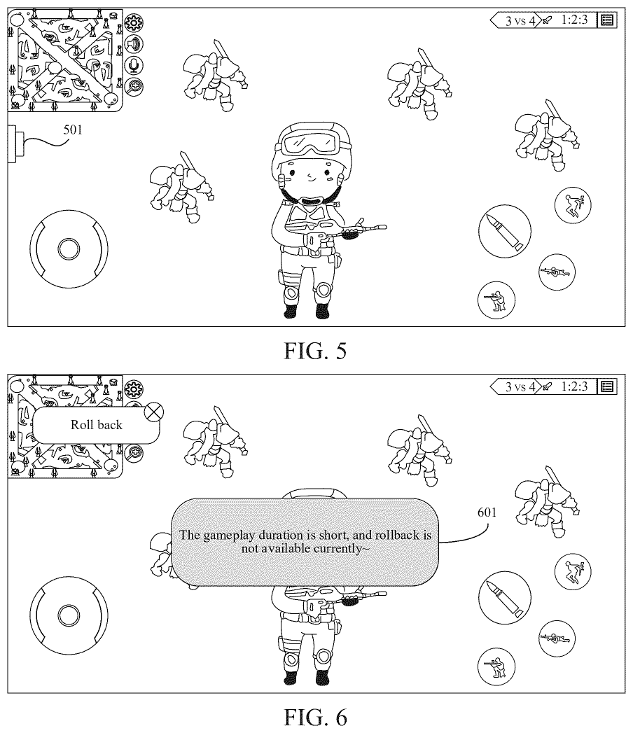

A first control may be further displayed in the first game picture, and the first control is configured to hide the rollback control. As shown in FIG. 4, a control 407 is the first control. In response to a trigger operation for the first control, display of the rollback control is canceled in the first game picture, and a second control is displayed in the first game picture. The second control is configured to display the rollback control. FIG. 5 is another schematic diagram of displaying a first game picture according to an embodiment of this application. The rollback control is not displayed in the first game picture shown in FIG. 5, and a second control 501 is displayed. In response to a trigger operation for the second control, display of the second control is canceled in the first game picture, and the rollback control is displayed in the first game picture.

The trigger operation for the first control may be a click/tap operation for the first control, or may be another operation for the first control. This is not limited in this embodiment of this application. The trigger operation for the second control is similar to the trigger operation for the first control Details are not described herein again.

In a possible implementation, a process of displaying a second game picture in response to a trigger operation of a rollback function includes: in response to the trigger operation of the rollback function, determining a reference value according to a frame rate and a reference duration of a game, and determining a second value based on the reference value being less than a first value and according to the first value and the reference value, the first value being a frame number corresponding to the first game picture in the game, and the second value being a frame number corresponding to the second game picture in the game; and obtaining the second game picture according to the second value, and displaying the second game picture. The reference duration is a duration corresponding to the rollback function, and the reference value is a number of picture frames requiring rollback. The duration corresponding to the rollback function is a duration set by a developer of the game, or the duration corresponding to the rollback function is a duration set by an object participating in the game. This is not limited in this embodiment of this application. For example, if the duration corresponding to the rollback function is 10 seconds, the reference duration is 10 seconds. The frame rate of the game is a frequency at which a bitmap image with a frame as a unit continuously appears on a display. The frame rate of the game may be a frame rate set by a developer of the game, or may be a frame rate set by an object participating in the game. This is not limited in this embodiment of this application. For example, the frame rate of the game is 30 frames/second. That is, 30 frames of game pictures are displayed in one second.

A process of determining the reference value according to a frame rate of the game and a reference duration includes: determining a product of the frame rate of the game and the reference duration as the reference value. For example, if the frame rate of the game is 30 frames/second, and the reference duration is 10 seconds, the reference value is 30*10=300.

After the reference value is determined, a magnitude relationship between the reference value and the first value needs to be determined. If the reference value is less than the first value, it indicates that rollback is available. If the reference value is not less than the first value, it indicates that rollback is not available.

It can be seen that since the frame rate of the same game running on different terminal devices may vary, and the frame rate of different games running on the same terminal device may also vary, after a frame number corresponding to a reference duration is determined based on the frame rate of the game, a rollback function may be accurately implemented for the current game. Moreover, whether the rollback function can be implemented currently may be further determined according to a progress (a historical frame number) of the game that has been achieved, thereby ensuring the implementation correctness of the rollback function.

First prompt information is displayed in the first game picture based on the reference value being not less than the first value. The first prompt information is configured for indicating that rollback is not available. Content of the first prompt information may be any content. This is not limited in this embodiment of this application. For example, the content of the first prompt information is “The gameplay duration is short, and rollback is not available currently-”. FIG. 6 is another schematic diagram of displaying a first game picture according to an embodiment of this application. First prompt information 601 is displayed in the first game picture shown in FIG. 6.

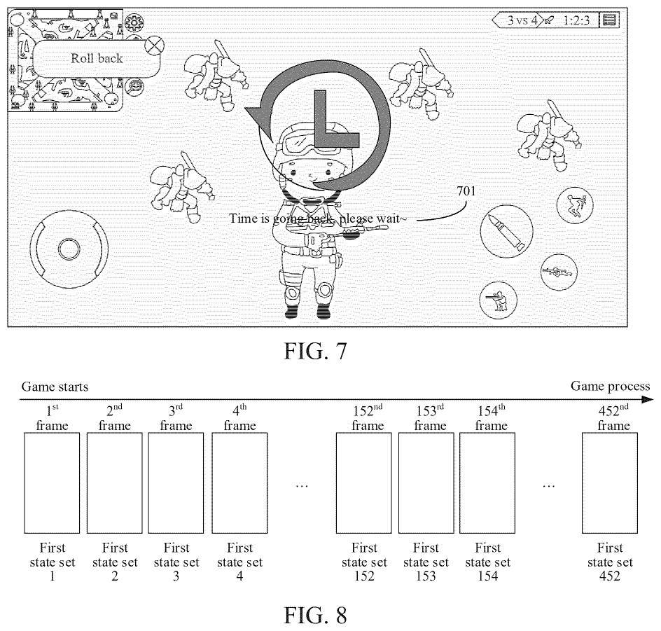

In some embodiments, based on the reference value being less than the first value, second prompt information is displayed in the first game picture. The second prompt information is configured for indicating that the second game picture is being obtained. Content of the second prompt information may be any content. This is not limited in this embodiment of this application. For example, the content of the second prompt information is “Time is going back, please wait-”. FIG. 7 is another schematic diagram of displaying a first game picture according to an embodiment of this application. Second prompt information 701 is displayed in the first game picture shown in FIG. 7. After the second game picture is obtained, displaying of the second prompt information is canceled, and the second game picture is displayed.

A process of determining the second value based on the reference value being less than the first value and according to the first value and the reference value includes: using the first value as a minuend, using the reference value as a subtrahend, and determining a difference between the first value and the reference value as the second value. For example, if the first value is 452, and the reference value is 300, the second value is 152, that is, the second game picture is the 152^{nd} frame of game picture of the game.

In a possible implementation, a process of obtaining the second game picture according to the second value includes: obtaining, according to the second value, an object state of the virtual object included in the second game picture; and obtaining the second game picture according to the object state of the virtual object included in the second game picture. Alternatively, the terminal device sends a picture obtaining request to the server, the picture obtaining request carrying a second value, and the picture obtaining request being configured for obtaining the second game picture; the server receives the picture obtaining request, parses the picture obtaining request to obtain the second value, obtains, according to the second value, the object state of the virtual object included in the second game picture, and obtains the second game picture according to the object state of the virtual object included in the second game picture; and the server sends the second game picture to the terminal device, so that the terminal device obtains the second game picture.

During a game, an object state of the virtual object varies in different game pictures. Therefore, to accurately roll back the game from the current first game picture to the historical second game picture, the terminal device accurately rolls back the game to the second game picture by obtaining the object state of the virtual object in the second game picture, thereby ensuring the accuracy of the second game picture.

The terminal device obtains, according to the second value, the object state of the virtual object included in the second game picture in the following three implementations.

Implementation 1: The terminal device stores first state sets corresponding to frames of game pictures from the first frame of game picture of the game to the first game picture and a correspondence between the first state sets corresponding to the frames of game pictures and frame numbers corresponding to the frames of game pictures. The first state set corresponding to any frame of game picture includes an object state of the virtual object included in the any frame of game picture. The first state set corresponding to a game picture corresponding to the second value is determined from the first state sets corresponding to the frames of game pictures, and an object state of the virtual object included in the determined first state set is determined as the object state of the virtual object included in the second game picture.

In some embodiments, each time the terminal device displays one frame of game picture, an object state of the virtual object included in the frame of game picture is recorded, a first state set corresponding to the frame of game picture is generated according to the object state of the virtual object included in the frame of game picture, and the first state set corresponding to the frame of game picture and a frame number corresponding to the frame of game picture are correspondingly stored in the terminal device.

For example, if the game progresses to the 452^{nd} frame, which means that the first game picture is the 452^{nd} frame of game picture of the game, the terminal device stores first state sets corresponding to frames of game pictures from the first frame of game picture to the 452^{nd} frame of game picture of the game, and a correspondence between the first state sets corresponding to the frames of game pictures and frame numbers corresponding to the frames of game pictures. The following Table 1 is an exemplary table of a correspondence between frame numbers corresponding to frames of game pictures and first state sets corresponding to the frames of game pictures stored in a terminal device according to an embodiment of this application.

TABLE 1

| Frame number corresponding | First state set corresponding |
|---|---|
| to a game picture | to a game picture |
| 1 | First state set 1 |
| 2 | First state set 2 |
| 3 | First state set 3 |
| 4 | First state set 4 |
| 5 | First state set 5 |
| 6 | First state set 6 |
| 7 | First state set 7 |
| 8 | First state set 8 |
| 9 | First state set 9 |
| 10 | First state set 10 |
| . . . | . . . |
| 452 | First state set 452 |

It can be learned from Table 1 that, the 1^{st} state set corresponding to the 1^{st} frame of game picture of the game is the first state set 1, the first state set corresponding to the 2^{nd} frame of game picture of the game is the first state set 2, and the first state sets corresponding to other frames of game pictures of the game are shown in Table 1. Details are not described herein again.

The terminal device stores the first state sets corresponding to the frames of game pictures of the game. Table 1 is merely an example of the first state sets corresponding to the 452 frames of game pictures according to this embodiment of this application and is not limited thereto.

For example, if the second value is 152, an object state of the virtual object included in the first state set corresponding to a game picture with a corresponding frame number of 152 is used as the object state of the virtual object included in the second game picture. That is, an object state of the virtual object included in the first state set 152 is used as the object state of the virtual object included in the second game picture.

FIG. 8 is a schematic diagram of a process of obtaining an object state of a virtual object included in a second game picture according to an embodiment of this application. If the first value is 452, and the second value is 152, the terminal device stores the first state sets corresponding to the frames of game pictures from the first frame of game picture to the 452^{nd} frame of game picture of the game. The first state sets corresponding to the frames of game pictures are shown in FIG. 8. An object state of the virtual object included in the first state set corresponding to a game picture with a corresponding frame number of 152 is used as the object state of the virtual object included in the second game picture.

This manner only requires determining a frame number of a game picture to which the game is rolled back (namely, the second game picture), and then obtaining a first state set corresponding to the game picture of the frame number, which can save the computing power of the terminal device. However, storing state sets corresponding to the frames of game pictures in the terminal device occupies a large storage space of the terminal device. As the game progresses, a quantity of displayed game pictures increases, and a quantity of state sets stored in the terminal device also increases, which reduces the running smoothness of the game, affecting the gaming experience of the player.

In some embodiments, after the object state of the virtual object included in the second game picture is obtained, since the second game picture needs to be displayed subsequently to continue the game starting from the second game picture, the first state sets corresponding to the frames of game pictures from the second game picture (namely, a second-value frame of game picture) to the first game picture are not needed. Therefore, after the object state of the virtual object included in the second game picture is obtained, the first state sets corresponding to the frames of game pictures from the second game picture to the first game picture may be further deleted, to save an internal memory space of the terminal device.

In a possible implementation, the foregoing manner of storing the first state sets corresponding to the frames of game pictures of the game in the terminal device needs to occupy a larger internal memory of the terminal device. Therefore, each time after obtaining the first state set corresponding to one frame of game picture of the game, the terminal device may send the first state set corresponding to the frame of game picture and the frame number corresponding to the frame of game picture to the server, and the server stores the first state set corresponding to the frame of game picture and the correspondence between the frame number corresponding to the frame of game picture and the first state set corresponding to the frame of game picture. In this way, the first state sets corresponding to the frames of game pictures may not be stored in the terminal device, thereby saving the internal memory space of the terminal device.

When the first state sets corresponding to the frames of game pictures from the first frame of game picture to the first game picture are stored in the server, a process of obtaining, according to the second value, the object state of the virtual object included in the second game picture includes: sending a first obtaining request to the server, the first obtaining request carrying the second value. After receiving the first obtaining request, the server parses the first obtaining request, to obtain the second value; the server determines an object state of the virtual object included in a first state set corresponding to a game picture that is with a corresponding frame number being the second value and is in the first frame of game picture to the first game picture stored in the server as the object state of the virtual object included in the second game picture; and the server sends the object state of the virtual object included in the second game picture to the terminal device, so that the terminal device obtains the object state of the virtual object included in the second game picture.

A storage manner for the first state sets corresponding to the frames of game pictures from the first frame of game picture to the first game picture in the server is similar to that in the terminal device Details are not described herein again.

For example, if the second value is 152, the first obtaining request carries 152, and the server determines an object state of the virtual object included in the first state set 152 as the object state of the virtual object included in the second game picture, and further sends the object state of the virtual object included in the first state set 152 to the terminal device.

In a possible implementation, after sending, to the terminal device, the object state of the virtual object included in the second game picture, the server may alternatively delete the first state sets corresponding to the frames of game pictures from the second game picture to the first game picture, to save an internal memory space of the server.

Since the first state sets corresponding to the frames in the game are prestored, when the game needs to be rolled back to the second game picture, the first state set corresponding to the second value can be efficiently matched from the prestored first state sets based on the frame number (namely, the second value) of the second game picture. The first state set can accurately identify the object state of the virtual object in the second game picture of the game, thereby improving the efficiency of obtaining the object state.

Implementation 2: The terminal device stores a second state set corresponding to the first frame of game picture of the game and instructions corresponding to the frames of game pictures from the second frame of game picture to the first game picture. The instruction corresponding to an i^{th} frame of game picture is configured for indicating an instruction required for controlling a change of an object state from displaying an (i−1)^{th} frame of game picture to displaying the i^{th} frame of game picture, and the second state set includes an object state of the virtual object included in the first frame of game picture, where 1<i≤the first value. The instructions respectively corresponding to the second frame of game picture to the second game picture are determined from the instructions corresponding to the frames of game pictures according to the second value; and the object state of the virtual object included in the second game picture is obtained according to the second state set and the instructions respectively corresponding to the second frame of game picture to the second game picture.

In some embodiments, a process of obtaining, according to the second state set and the instructions respectively corresponding to the second frame of game picture to the second game picture, the object state of the virtual object included in the second game picture includes: obtaining, according to the object state of the virtual object included in the first frame of game picture and the instruction corresponding to the second frame of game picture, the object state of the virtual object included in the second frame of game picture; and obtaining, based on an object state of the virtual object included in the (i−1)^{th} frame of game picture and the instruction corresponding to the i^{th} frame of game picture, an object state of the virtual object included in the i^{th} frame of game picture according to the second state set, until the object state of the virtual object included in the second game picture is obtained. That is, the object state of the virtual object included in the second game picture is obtained.

For example, if the first value is 10, and the second value is 5, and an object state of the virtual object included in the 5^{th} frame of game picture needs to be obtained. The terminal device stores an object state of the virtual object included in the 1^{st} frame of game picture and instructions corresponding to frames of game pictures from the 2^{nd} frame of game picture to the 10^{th} frame of game picture. The instruction corresponding to the 2^{nd} frame of game picture, the instruction corresponding to the 3^{rd} frame of game picture, the instruction corresponding to the 4^{th} frame of game picture, and the instruction corresponding to the 5^{th} frame of game picture are obtained from the instructions corresponding to the frames of game pictures from the 2^{nd} frame of game picture to the 10^{th} tenth frame of game picture. Therefore, an object state of the virtual object included in the 2^{nd} frame of game picture is obtained according to the object state of the virtual object included in the 1^{st} frame of game picture and the instruction corresponding to the 2^{nd} frame of game picture; an object state of the virtual object included in the 3^{rd} frame of game picture is obtained according to the object state of the virtual object included in the 2^{nd} frame of game picture and the instruction corresponding to the 3^{rd} frame of game picture; an object state of the virtual object included in the 4^{th} frame of game picture is obtained according to the object state of the virtual object included in the 3^{rd} frame of game picture and the instruction corresponding to the 4^{th} frame of game picture; and an object state of the virtual object included in the 5^{th} frame of game picture is obtained according to the object state of the virtual object included in the 4^{th} frame of game picture and the instruction corresponding to the 5^{th} frame of game picture. That is, the object state of the virtual object included in the second game picture is obtained.

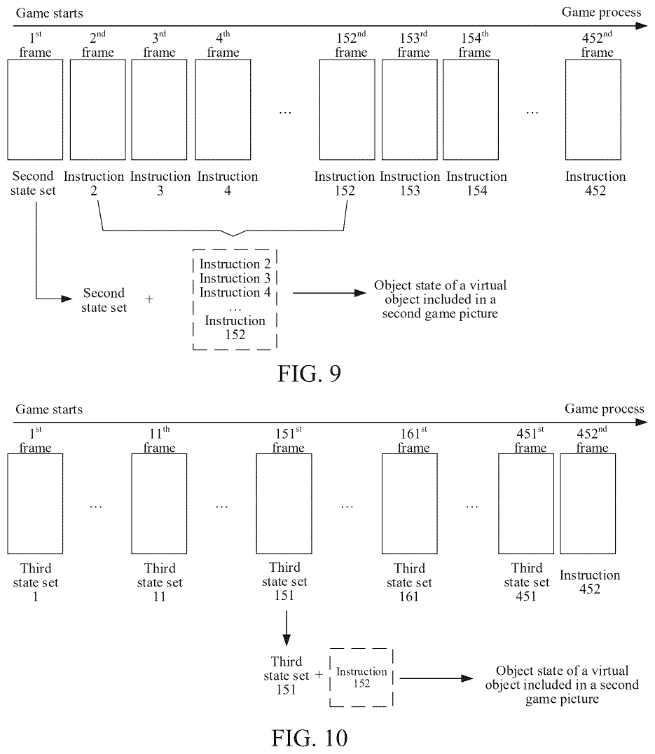

FIG. 9 is another schematic diagram of a process of obtaining an object state of a virtual object included in a second game picture according to an embodiment of this application. If the first value is 452, the second value is 152, the terminal device stores a second state set corresponding to the first frame of game picture of the game and instructions corresponding to the frames of game pictures from the second frame of game picture to the 452^{nd} frame of game picture. The instructions corresponding to the frames of game pictures are shown in FIG. 9. The object state of the virtual object included in the second game picture is obtained according to the second state set corresponding to the first frame of game picture and the instructions corresponding to the frames of game pictures from the second frame of game picture to the 152^{nd} frame of game picture.

An advantage of this manner is that in a game process, only the state set corresponding to the first frame of game picture and instructions corresponding to subsequent frames of game pictures need to be stored, without the need to store state sets corresponding to all frames of game pictures, thereby greatly reducing the amount of stored data. However, as the game progresses, a quantity of displayed game pictures increases, and a quantity of instructions that need to be stored also increases. Each rollback requires obtaining instructions corresponding to all game pictures between a game picture to which the game is rolled back and the first frame of game picture, and then the terminal device obtains, according to an instruction set corresponding to the first frame of game picture and the instructions corresponding to all the game pictures between the game picture to which the game is rolled back and the first frame of game picture, an object state of the virtual object included in the game picture to which the game is rolled back. This results in a significant computational pressure on the terminal device, and a longer time required for obtaining the object state of the virtual object included in the second game picture, which extends the time for obtaining the second game picture, and affecting the gaming experience of the player.

In a possible implementation, after the object state of the virtual object included in the second game picture is obtained, since the second game picture needs to be displayed subsequently to continue the game starting from the second game picture, the instructions corresponding to the frames of game pictures from the second game picture to the first game picture are not needed. Therefore, the instructions corresponding to the frames of game pictures from the second game picture to the first game picture may further be deleted, to save the internal memory space of the terminal device.

In a possible implementation, the foregoing manner of storing the second state set corresponding to the first frame of game picture of the game and instructions corresponding to other frames of game pictures in the terminal device needs to occupy a larger internal memory of the terminal device. Therefore, after obtaining the second state set corresponding to the first frame of game picture of the game, the terminal device may send the second state set corresponding to the first frame of game picture and the frame number corresponding to the first frame of game picture to the server. The server stores the second state set corresponding to the first frame of game picture and the correspondence between the frame number corresponding to the first frame of game picture and the second state set corresponding to the first frame of game picture. After obtaining the instructions corresponding to the other frames of game pictures, the terminal device sends the instructions corresponding to the frames of game pictures and frame numbers corresponding to the frames of game pictures to the server. The server stores the instructions corresponding to the frames of game pictures and a correspondence between the frame numbers corresponding to the frames of game pictures and the instructions corresponding to the frames of game pictures. In this way, the second state set corresponding to the first frame of game picture and the instructions corresponding to the frames of game pictures may not be stored in the terminal device, thereby saving the internal memory space of the terminal device.

When the second state set corresponding to the first frame of game picture and the instructions corresponding to the second frame of game picture to the first game picture are stored in the server, the process of obtaining, according to the second value, the object state of the virtual object included in the second game picture includes: sending a second obtaining request to the server, the second obtaining request carrying the second value. After receiving the second obtaining request, the server parses the second obtaining request, to obtain the second value; the server obtains, from a storage space of the server, the second state set corresponding to the first frame of game picture and the instructions corresponding to the frames of game pictures from the second frame of game picture to the second game picture, and the server obtains, according to the second state set and the instructions corresponding to the frames of game pictures from the second frame of game picture to the second game picture, the object state of the virtual object included in the second game picture; and the server sends the object state of the virtual object included in the second game picture to the terminal device, so that the terminal device obtains the object state of the virtual object included in the second game picture.

In some embodiments, after obtaining, from the storage space of the server, the second state set corresponding to the first frame of game picture and the instructions corresponding to the frames of game pictures from the second frame of game picture to the second game picture, the server sends the second state set corresponding to the first frame of game picture and the instructions corresponding to the frames of game pictures from the second frame of game picture to the second game picture to the terminal device. The terminal device receives the second state set corresponding to the first frame of game picture and the instructions corresponding to the frames of game pictures from the second frame of game picture to the second game picture, and obtains, according to the second state set corresponding to the first frame of game picture and the instructions corresponding to the frames of game pictures from the second frame of game picture to the second game picture, the object state of the virtual object included in the second game picture.

A storage manner for the instructions corresponding to the frames of game pictures from the second frame of game picture to the first game picture in the server is similar to that in the terminal device Details are not described herein again.

For example, if the second value is 5, the second obtaining request carries 5, and the server obtains the second state set corresponding to the first frame of game picture, and the instruction corresponding to the 2^{nd} frame of game picture, the instruction corresponding to the 3^{rd} frame of game picture, the instruction corresponding to the 4^{th} frame of game picture, and the instruction corresponding to the 5^{th} frame of game picture. An object state of the virtual object included in the 2^{nd} frame of game picture is obtained according to the object state of the virtual object included in the second state set and the instruction corresponding to the 2^{nd} frame of game picture, an object state of the virtual object included in the 3^{rd} frame of game picture is obtained according to the object state of the virtual object included in the 2^{nd} frame of game picture and the instruction corresponding to the 3^{rd} frame of game picture, an object state of the virtual object included in the 4^{th} frame of game picture is obtained according to the object state of the virtual object included in the 3^{rd} frame of game picture and the instruction corresponding to the 4^{th} frame of game picture, and an object state of the virtual object included in the 5^{th} frame of game picture is obtained according to the object state of the virtual object included in the 4^{th} frame of game picture and the instruction corresponding to the 5^{th} frame of game picture. The object state of the virtual object included in the 5^{th} frame of game picture is then sent to the terminal device.

In a possible implementation, after the server sends the object state of the virtual object included in the second game picture to the terminal device, or after the server sends the second state set corresponding to the first frame of game picture and the instructions corresponding to the frames of game pictures from the second frame of game picture to the second game picture to the terminal device, the server may alternatively delete the instructions corresponding to the frame of game pictures from the second game picture to the first game picture, to save the internal memory space of the server.

Implementation 3: The terminal device stores third state sets corresponding to a plurality of frames of reference game pictures and a correspondence between the third state sets corresponding to the frames of reference game pictures and frame numbers corresponding to the frames of reference game pictures. A reference game picture is a game picture with a frame number satisfying a frame number requirement, and the third state set corresponding to any reference game picture includes an object state of the virtual object included in the any reference game picture. The object state of the virtual object included in the second game picture is determined based on the second value satisfying the frame number requirement and according to the third state set corresponding to the second game picture.

The frame number satisfying the frame number requirement may refer to a frame number at an interval of a reference quantity. For example, if the reference quantity is 10, the frame number satisfying the frame number requirement may be the 1^{st} frame, the 11^{th} frame, the 21^{st} frame, or the like.

For example, if the first value is 71, and the second value is 61, the terminal device stores the third state set corresponding to the 1^{st} frame of game picture, the third state set corresponding to the 11^{th} frame of game picture, the third state set corresponding to the 21^{st} frame of game picture, the third state set corresponding to the 31^{st} frame of game picture, the third state set corresponding to the 41^{st} frame of game picture, the third state set corresponding to the 51^{st} frame of game picture, the third state set corresponding to the 61^{st} frame of game picture, and the third state set corresponding to the 71^{st} frame of game picture. Therefore, an object state of the virtual object included in the third state set corresponding to the 61^{st} frame of game picture is used as the object state of the virtual object included in the second game picture.

In some embodiments, after the terminal device obtains the object state of the virtual object included in the second game picture, since the second game picture needs to be displayed subsequently to continue the game starting from the second game picture, the third state sets corresponding to reference game pictures with a corresponding frame number not less than the second value are not needed. Therefore, the third state sets corresponding to the reference game pictures with the corresponding frame number greater than or equal to the second value may be further deleted, to save the internal memory space of the terminal device.

In a possible implementation, the foregoing manner of storing the third state sets corresponding to the reference game pictures in the terminal device needs to occupy a larger internal memory of the terminal device. Therefore, after obtaining the third state sets corresponding to the reference game pictures, the terminal device may send the third state sets corresponding to the reference game pictures and the frame numbers corresponding to the reference game pictures to the server, and the server stores the third state sets corresponding to the reference game pictures and the correspondence between the frame numbers corresponding to the reference game pictures and the third state sets corresponding to the reference game pictures. In this way, the third state sets corresponding to the reference game pictures may not be stored in the terminal device, thereby saving the internal memory space of the terminal device.

When the third state sets corresponding to the reference game pictures are stored in the server, the process of obtaining, according to the second value, the object state of the virtual object included in the second game picture includes: sending a third obtaining request to the server, the third obtaining request carrying the second value. After receiving the third obtaining request, the server parses the third obtaining request, to obtain the second value; the server obtains, from the storage space of the server, the third state set corresponding to a reference game picture with a corresponding frame number being the second value, and determines an object state of the virtual object included in the third state set corresponding to the reference game picture with the corresponding frame number being the second value as the object state of the virtual object included in the second game picture; and the server sends the object state of the virtual object included in the second game picture to the terminal device, so that the terminal device obtains the object state of the virtual object included in the second game picture.

In a possible implementation, after the server sends the object state of the virtual object included in the second game picture to the terminal device, the server may alternatively delete the third state sets corresponding to the reference game pictures with the corresponding frame number not less than the second value, to save the internal memory space of the server.

In some embodiments, the terminal device not only stores the third state sets corresponding to the plurality of frames of reference game pictures and the correspondence between the third state sets corresponding to the frames of reference game pictures and the frame numbers corresponding to the frames of reference game pictures, but also stores instructions corresponding to frames of game pictures between two adjacent frames of reference game pictures. An instruction corresponding to any game picture between two adjacent frames of reference game pictures is configured for indicating an instruction required for displaying a previous frame of game picture of the any game picture to displaying the any game picture. The third state set corresponding to the any reference game picture includes an object state of the virtual object included in the any reference game picture.

The third state set corresponding to a third game picture is determined from the third state sets corresponding to the plurality of frames of reference game pictures based on the second value not satisfying the frame number requirement and according to the second value, the third game picture being a reference game picture with a maximum frame number among the reference game pictures with the corresponding frame number less than the second value; instructions respectively corresponding to a next frame of game picture of the third game picture to the second game picture are determined from the instructions corresponding to the frames of game pictures; and the object state of the virtual object included in the second game picture is obtained according to the third state set corresponding to the third game picture and the instructions respectively corresponding to the next frame of game picture of the third game picture to the second game picture.

For example, according to the third state set corresponding to the third game picture, instructions corresponding to frames of game pictures between the third game picture and the second game picture, and the instruction corresponding to the second game picture, the process of obtaining the object state of the virtual object included in the second game picture may include: obtaining, according to an object state of the virtual object included in the third game picture and the instructions corresponding to the frames of game pictures between the third game picture and the second game picture, an object state of the virtual object included in a fourth game picture, the fourth game picture being a previous frame of game picture of the second game picture; and obtaining, according to the object state of the virtual object included in the fourth game picture and the instruction corresponding to the second game picture, the object state of the virtual object included in the second game picture. That is, the object state of the virtual object included in the second game picture is obtained.

For example, if the first value is 71, and the second value is 55, the terminal device stores the third state set corresponding to the 1^{st} frame of game picture, the third state set corresponding to the 11^{th} frame of game picture, the third state set corresponding to the 21^{st} frame of game picture, the third state set corresponding to the 31^{st} frame of game picture, the third state set corresponding to the 41^{st} frame of game picture, the third state set corresponding to the 51^{st} frame of game picture, the third state set corresponding to the 61^{st} frame of game picture, the third state set corresponding to the 71^{st} frame of game picture, instructions corresponding to frames of game pictures between the 1^{st} frame of game picture and the 11^{th} frame of game picture, instructions corresponding to frames of game pictures between the 11^{th} frame of game picture and the 21^{st} frame of game picture, instructions corresponding to frames of game pictures between the 21^{st} frame of game picture and the 31^{st} frame of game picture, instructions corresponding to frames of game pictures between the 31^{st} frame of game picture and the 41^{st} frame of game picture, instructions corresponding to frames of game pictures between the 41^{st} frame of game picture and the 51^{st} frame of game picture, instructions corresponding to frames of game pictures between the 51^{st} frame of game picture and the 61^{st} frame of game picture, and instructions corresponding to frames of game pictures between the 61^{st} frame of game picture and the 71^{st} frame of game picture. Since the second value is 55, the terminal device obtains the third state set corresponding to the 51^{st} frame of game picture, the instruction corresponding to the 52^{nd} frame of game picture, the instruction corresponding to the 53^{rd} frame of game picture, the instruction corresponding to the 54^{th} frame of game picture, and the instruction corresponding to the 55^{th} frame of game picture, obtains, according to an object state of the virtual object included in the 51^{st} frame of game picture and the instruction corresponding to the 52^{nd} frame of game picture, an object state of the virtual object included in the 52^{nd} frame of game picture, obtains, according to the object state of the virtual object included in the 52^{nd} frame of game picture and the instruction corresponding to the 53^{rd} frame of game picture, an object state of the virtual object included in the 53^{rd} frame of game picture, obtains, according to the object state of the virtual object included in the 53^{rd} frame of game picture and the instruction corresponding to the 54^{th} frame of game picture, an object state of the virtual object included in the 54^{th} frame of game picture, and obtains, according to the object state of the virtual object included in the 54^{th} frame of game picture and the instruction corresponding to the 55^{th} frame of game picture, an object state of the virtual object included in the 55^{th} frame of game picture. That is, the object state of the virtual object included in the second game picture is obtained.

FIG. 10 is another schematic diagram of a process of obtaining an object state of a virtual object included in a second game picture according to an embodiment of this application. If the first value is 452, and the second value is 152, the terminal device stores third state sets corresponding to frames of reference game pictures among reference game pictures with frame numbers satisfying the frame number requirement and instructions corresponding to frames of game pictures between two adjacent frames of reference game pictures, obtains a third state set 151 corresponding to the 151^{st} frame of game picture and an instruction 152 corresponding to the 152^{nd} frame of game picture, and obtains, according to the third state set 151 and the instruction 152, the object state of the virtual object included in the second game picture.

This manner is a combination of implementation 1 and implementation 2, and the terminal device does not need to store a state set corresponding to each displayed frame of game picture. Compared with implementation 1, the internal memory space of the terminal device can be saved. Moreover, compared with implementation 2, the computational pressure on the terminal device can be reduced, the efficiency of obtaining the object state of the virtual object included in the second game picture can be improved, and the efficiency of obtaining the second game picture can be improved according to the third state set corresponding to a reference game picture (namely, the third game picture) corresponding to a maximum frame number among the reference game pictures with the corresponding frame number less than the second value, the instructions corresponding to the frames of game pictures between the third game picture and the second game picture, and the instruction corresponding to the second game picture.

In a possible implementation, after the terminal device obtains the object state of the virtual object included in the second game picture, since the second game picture needs to be displayed subsequently to continue the game starting from the second game picture, the third state sets corresponding to the reference game pictures with the corresponding frame number greater than the second value and the instructions corresponding to the game picture with the corresponding frame number not less than the second value are not needed. Alternatively, the third state sets corresponding to the reference game pictures with the frame number greater than the second value and the instructions corresponding to the game pictures with the frame number not less than the second value may be deleted to save the internal memory space of the terminal device.

In a possible implementation, the foregoing manner of storing the third state sets corresponding to the reference game pictures and the instructions corresponding to the frames of game pictures between two adjacent frames of reference game pictures in the terminal device needs to occupy a larger internal memory of the terminal device. Therefore, after obtaining the third state sets corresponding to the reference game pictures of the game, the terminal device may send the third state sets corresponding to the reference game pictures and the frame numbers corresponding to the reference game pictures to the server. The server stores the third state sets corresponding to the reference game pictures and the correspondence between the frame numbers corresponding to the reference game pictures and the third state sets corresponding to the reference game pictures. After obtaining the instructions corresponding to the frames of game pictures between two adjacent frames of reference game pictures, the terminal device sends the instructions corresponding to the frames of game pictures and the frame numbers corresponding to the frames of game pictures to the server. The server stores the instructions corresponding to the frames of game pictures and the correspondence between the frame numbers corresponding to the frames of game pictures and the instructions corresponding to the frames of game pictures. In this way, the third state sets corresponding to the reference game pictures and the instructions corresponding to the frame of game pictures between two adjacent frames of reference game pictures may not be stored in the terminal device, thereby saving the internal memory space of the terminal device.

When the third state sets corresponding to the reference game pictures and the instructions corresponding to the frames of game pictures between two adjacent frames of reference game pictures are stored in the server, the process of obtaining, according to the second value, the object state of the virtual object included in the second game picture includes: sending a fourth obtaining request to the server, the fourth obtaining request carrying the second value. After receiving the fourth obtaining request, the server parses the fourth obtaining request, to obtain the second value; the server obtains, from the storage space of the server, the third state set corresponding to the third game picture, instructions corresponding to frames of game pictures in the third game picture and the second game picture, and the instruction corresponding to the second game picture, and the server obtains, according to the third state set corresponding to the third game picture, the instruction corresponding to the frames of game pictures in the third game picture and the second game picture, and the instruction corresponding to the second game picture, the object state of the virtual object included in the second game picture; and the server sends the object state of the virtual object included in the second game picture to the terminal device, so that the terminal device obtains the object state of the virtual object included in the second game picture. The third game picture is a reference game picture with a corresponding maximum frame number among the reference game pictures with the corresponding frame number less than the second value.

In some embodiments, after obtaining, from the storage space of the server, the third state set corresponding to the third game picture, the instructions corresponding to the frames of game pictures in the third game picture and the second game picture, and the instruction corresponding to the second game picture, the server sends the third state set corresponding to the third game picture, the instructions corresponding to the frames of game pictures in the third game picture and the second game picture, and the instruction corresponding to the second game picture to the terminal device. The terminal device receives the third state set corresponding to the third game picture, the instructions corresponding to the frames of game pictures in the third game picture and the second game picture, and the instruction corresponding to the second game picture, and obtains, according to the third state set corresponding to the third game picture, the instructions corresponding to the frames of game pictures in the third game picture and the second game picture, and the instruction corresponding to the second game picture, the object state of the virtual object included in the second game picture.

In a possible implementation, after the server sends the object state of the virtual object included in the second game picture to the terminal device, or after the server sends the third state set corresponding to the third game picture, the instructions corresponding to the frames of game pictures in the third game picture and the second game picture, and the instruction corresponding to the second game picture to the terminal device, the server may alternatively delete the third state sets corresponding to the reference game pictures with the corresponding frame number greater than the second value, and delete the instructions corresponding to the game pictures with the corresponding frame number not less than the second value, to save the internal memory space of the server.

In a possible implementation, after obtaining the object state of the virtual object included in the second game picture, the terminal device performs picture rendering according to the object state of the virtual object included in the second game picture, to obtain the second game picture.

In some embodiments, the terminal device may further obtain a state of a static object included in the second game picture, and perform picture rendering according to the state of the static object included in the second game picture and the object state of the virtual object included in the second game picture, to obtain the second game picture.

The process of obtaining, by the server according to the second value, the object state of the virtual object included in the second game picture is described above. After the server obtains the object state of the virtual object included in the second game picture, the server performs picture rendering according to the object state of the virtual object included in the second game picture, to obtain the second game picture. The server sends the second game picture to the terminal device, so that the terminal device obtains the second game picture. In some embodiments, the server obtains a state of a static object included in the second game picture, and performs picture rendering according to the state of the static object included in the second game picture and the object state of the virtual object included in the second game picture, to obtain the second game picture. The server sends the second game picture to the terminal device, so that the terminal device obtains the second game picture.

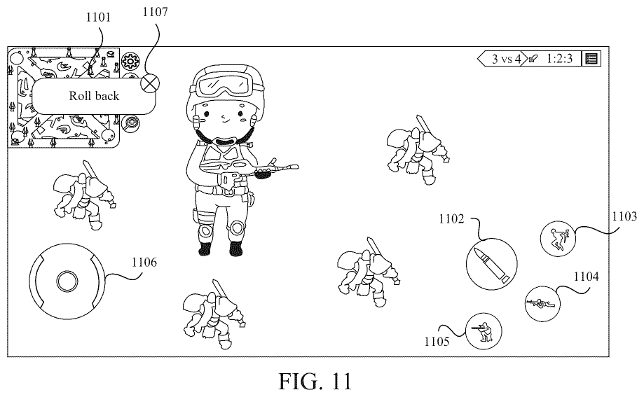

In a possible implementation, after the second game picture is obtained, the second game picture is displayed. FIG. 11 is a schematic diagram of displaying a second game picture according to an embodiment of this application. A state of the virtual object located in the virtual environment and included in the second game picture is the object state of the virtual object in the second game picture.

Operation 204: Control the virtual object to replay the game starting from the historical state.

In some embodiments, a rollback control, a fire control, a jump control, a prone control, a crouch control, a direction control, and a first control may be further displayed in the second game picture. As shown in FIG. 11, a control 1101 is a rollback control, a control 1102 is a fire control, a control 1103 is a jump control, a control 1104 is a prone control, a control 1105 is a crouch control, a control 1106 is a direction control, and a control 1107 is a first control. The virtual object is controlled, by using at least one of the controls, to replay the game starting from the historical state.

In a possible implementation, an advance control (not shown in FIG. 11) may be further displayed in the second game picture. The third game picture is displayed in response to a trigger operation for the advance control. The third game picture is a picture obtained after a game state of the virtual object in the virtual environment is advanced to a first state by controlling the game process. The virtual object is controlled to replay the game starting from the first state. Another control may be further displayed in the third game picture. This is not limited in this embodiment of this application.

A process of displaying the third game picture in response to the trigger operation for the advance control includes: determining, in response to the trigger operation for the advance control, a candidate value according to a frame rate of the game and a first duration, the first duration being a duration corresponding to the advance control, and the first duration being less than a reference duration; determining a third value according to the candidate value and the second value, a third-value frame of game picture of the game being the third game picture; and obtaining the third game picture based on the third value being not greater than the first value and being greater than the second value and according to the third value, and displaying the third game picture. In some embodiments, a process of determining the third value according to the candidate value and the second value includes: adding the candidate value and the second value, to obtain the third value. A process of obtaining the third game picture according to the third value is similar to the process of obtaining the second game picture according to the second value in operation 202 Details are not described herein again.

In some embodiments, third prompt information is displayed based on the third value being greater than the first value. The third prompt information is configured for indicating that advancement is not available. Content of the third prompt information may be any content. This is not limited in this embodiment of this application.

For example, the frame rate of the game is 30 frames/second, the reference duration corresponding to the rollback control is 10 seconds, and the first duration corresponding to the advance control is 5 seconds. The first game picture is the 452^{nd} frame of game picture of the game, and the rollback control is displayed in the first game picture. In response to a trigger operation for the rollback control, it is determined, according to the frame rate of the game and the reference duration, that 300 frames need to be rolled back, that is, the 152^{nd} frame of game picture of the game needs to be obtained. After the 152^{nd} frame of game picture of the game is obtained, the second game picture is displayed. The second game picture is the 152^{nd} frame of game picture of the game, and the advance control is displayed in the second game picture. In response to a trigger operation for the advance control, it is determined, according to the frame rate of the game and the first duration, that 150 frames need to be advanced. That is, the 302^{nd} frame of game picture of the game needs to be obtained. After the 302^{nd} frame of game picture of the game is obtained, the third game picture is displayed, and the third game picture is the 302^{nd} frame of game picture of the game.

According to the foregoing method, when the rollback function is triggered, the second game picture is displayed. The game state of the virtual object located in the virtual environment and included in the second game picture is the historical state, to control the virtual object to replay the game starting from the historical state. According to the method, when the player is accidentally hit in the first game picture, or triggers an incorrect operation in the first game picture, the player may use the rollback function to roll back to the second game picture prior to the first game picture, to continue the game with the object state in the second game picture, allowing the player a chance to restart, making the operation control manners for the game by the player more diversified, thereby improving the flexibility of operation control for the game by the player, and improving the gaming experience of the player to some extent.

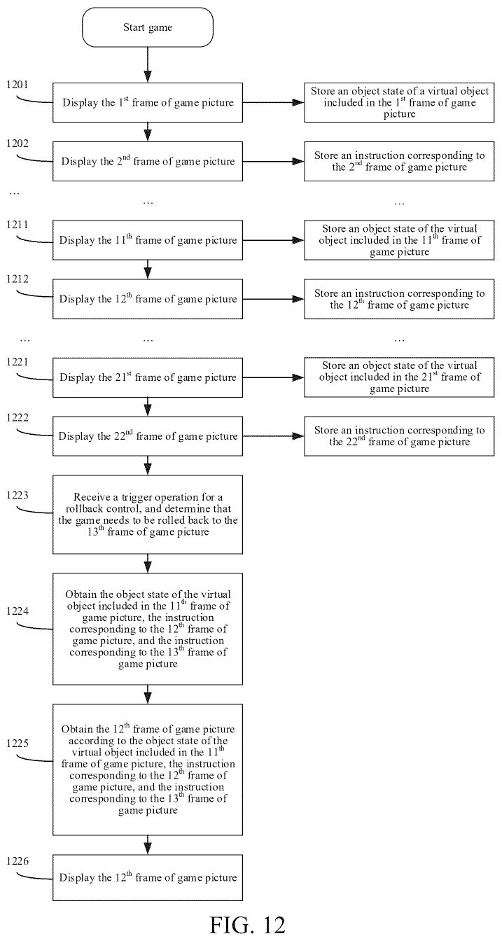

FIG. 12 is a flowchart of an operation control method according to an exemplary embodiment of this application. A currently displayed first game picture is the 22^{nd} frame of game picture of a game, and an object state of a virtual object included in one frame of game picture is stored at an interval of 10 frames. That is, the terminal device stores an object state of the virtual object included in the 1^{st} frame of game picture, an object state of the virtual object included in the 11^{th} frame of game picture, and an object state of the virtual object included in the 21^{st} frame of game picture. The process includes the following operation 1201 to operation 1226.

Operation 1201: Display the 1^{st} frame of game picture, and store the object state of the virtual object included in the 1^{st} frame of game picture.

Operation 1202: Display the 2^{nd} frame of game picture, and store an instruction corresponding to the 2^{nd} frame of game picture.

Processes of displaying the 3^{rd} frame of game picture to the 10^{th} frame of game picture are similar to the process of displaying the 2^{nd} frame of game picture Details are not described herein again.

Operation 1211: Display the 11^{th} frame of game picture, and store the object state of the virtual object included in the 11^{th} frame of game picture.

Operation 1212: Display the 12^{th} frame of game picture, and store an instruction corresponding to the 12^{th} frame of game picture.

Processes of displaying the 13^{th} frame of game picture to the 20^{th} frame of game picture are similar to the process of displaying the 12^{th} frame of game picture Details are not described herein again.

Operation 1221: Display the 21^{st} frame of game picture, and store the object state of the virtual object included in the 21^{st} frame of game picture.

Operation 1222: Display the 22^{nd} frame of game picture, and store an instruction corresponding to the 22^{nd} frame of game picture.

Operation 1223: Receive a trigger operation for a rollback control, and determine, according to a frame number of a currently displayed game picture and a duration corresponding to the rollback control, that the game needs to be rolled back to the 13^{th} frame of game picture.

In some embodiments, a process of determining, according to a frame number of a currently displayed game picture and a duration corresponding to the rollback control, that the game needs to be rolled back to the 13^{th} frame of game picture is similar to the process of determining the second value in operation 202 Details are not described herein again.

Operation 1224: Obtain the object state of the virtual object included in the 11^{th} frame of game picture, the instruction corresponding to the 12^{th} frame of game picture, and the instruction corresponding to the 13^{th} frame of game picture.

Operation 1225: Obtain the 12^{th} frame of game picture according to the object state of the virtual object included in the 11^{th} frame of game picture, the instruction corresponding to the 12^{th} frame of game picture, and the instruction corresponding to the 13^{th} frame of game picture.

In some embodiments, a process of obtaining the 12^{th} frame of game picture is similar to the process of obtaining the second game picture Details are not described herein again.

Operation 1226: Display the 12^{th} frame of game picture.

In some embodiments, the process of displaying the 12^{th} frame of game picture is similar to the process of displaying the second game picture Details are not described herein again.

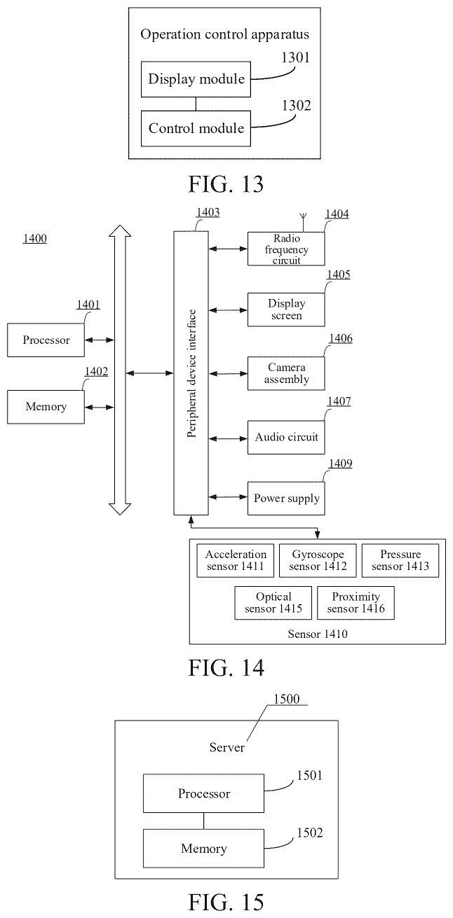

FIG. 13 is a schematic structural diagram of an operation control apparatus according to an embodiment of this application. As shown in FIG. 13, the apparatus includes:
a display module 1301, configured to display a first game picture, the first game picture including a virtual object located in a virtual environment; and
a control module 1302, configured to control the virtual object to play a game in the virtual environment,
the display module 1301 being further configured to display a second game picture in response to a trigger operation of a rollback function, the second game picture being a picture obtained by controlling a game process to roll back a game state of the virtual object in the virtual environment to a historical state; and
the control module 1302 being further configured to control the virtual object to replay the game starting from the historical state.

In a possible implementation, the apparatus further includes:
an obtaining module, configured to determine a reference value according to a frame rate of the game and a reference duration in response to a trigger operation of the rollback function, the reference duration being a duration corresponding to the rollback function, and the reference value being a number of picture frames requiring rollback; determine, based on the reference value being less than a first value, a second value according to the first value and the reference value, the first value being a frame number corresponding to the first game picture in the game, and the second value being a frame number corresponding to the second game picture in the game; and obtaining the second game picture according to the second value; and
a display module 1301, configured to display the second game picture.

In a possible implementation, the obtaining module is configured to obtain, according to the second value, an object state of the virtual object included in the second game picture; and obtain the second game picture according to the object state of the virtual object included in the second game picture.

In a possible implementation, the terminal device stores first state sets corresponding to frames of game pictures from the first frame of game picture of the game to the first game picture and a correspondence between the first state sets corresponding to the frames of game pictures and frame numbers corresponding to the frames of game pictures, and the first state set corresponding to any frame of game picture includes an object state of the virtual object included in the any frame of game picture.

The obtaining module is configured to determine the first state set corresponding to a game picture corresponding to the second value from the first state sets corresponding to the frames of game pictures, and determine an object state of the virtual object included in the determined first state set as the object state of the virtual object included in the second game picture.

In a possible implementation, the apparatus further includes:
a deletion module, configured to delete the first state sets respectively corresponding to the second game picture to the first game picture.

In a possible implementation, the terminal device stores a second state set corresponding to the first frame of game picture of the game, and instructions corresponding to frames of game pictures from the second frame of game picture to the first game picture, the instruction corresponding to an i^{th} frame of game picture is configured for indicating an instruction required for controlling a change of an object state from displaying an (i−1)^{th} frame of game picture to displaying the i^{th} frame of game picture, and the second state set includes an object state of the virtual object included in the first frame of game picture, where 1<i≤the first value; and
the obtaining module is configured to determine the instructions respectively corresponding to the second frame of game picture to the second game picture from the instructions corresponding to the frames of game pictures according to the second value; and obtain, according to the second state set and the instructions respectively corresponding to the second frame of game picture to the second game picture, the object state of the virtual object included in the second game picture.

In a possible implementation, the obtaining module is configured to obtain, according to the object state of the virtual object included in the first frame of game picture and the instruction corresponding to the second frame of game picture, the object state of the virtual object included in the second frame of game picture; and obtain, based on an object state of the virtual object included in the (i−1)^{th} frame of game picture and the instruction corresponding to the i^{th} frame of game picture, an object state of the virtual object included in the i^{th} frame of game picture according to the second state set, until the object state of the virtual object included in the second game picture is obtained.

In a possible implementation, the deletion module is further configured to delete the instructions corresponding to the frames of game pictures from the second game picture to the first game picture.

In a possible implementation, the terminal device stores third state sets corresponding to a plurality of frames of reference game pictures and a correspondence between the third state sets corresponding to the frames of reference game pictures and frame numbers corresponding to the frames of reference game pictures, the reference game picture is a game picture with a frame number satisfying a frame number requirement, and the third state set corresponding to any reference game picture includes an object state of the virtual object included in the any reference game picture; and
the obtaining module is configured to determine, based on the second value satisfying the frame number requirement and according to the third state set corresponding to the second game picture, the object state of the virtual object included in the second game picture.

In a possible implementation, the deletion module is further configured to delete the third state sets corresponding to the reference game pictures with a corresponding frame number not less than the second value.

In a possible implementation, the terminal device stores third state sets corresponding to a plurality of frames of reference game pictures, a correspondence between the third state sets corresponding to the frames of reference game pictures and frame numbers corresponding to the frames of reference game pictures, and instructions corresponding to frames of game pictures between two adjacent frames of reference game pictures, the reference game picture is a game picture with a frame number satisfying a frame number requirement, and the instruction corresponding to any game picture between two adjacent frames of reference game pictures is configured for indicating an instruction required for displaying a previous frame of game picture of the any game picture to displaying the any game picture, and the third state set corresponding to the any reference game picture includes an object state of the virtual object included in the any reference game picture; and
the obtaining module is configured to determine the third state set corresponding to a third game picture from the third state sets corresponding to the plurality of frames of reference game pictures based on the second value not satisfying the frame number requirement and according to the second value, the third game picture being a reference game picture with a maximum frame number among the reference game pictures with corresponding frame numbers less than the second value; determine instructions respectively corresponding to a next frame of game picture of the third game picture to the second game picture from the instructions corresponding to the frames of game pictures; and obtain, according to the third state set corresponding to the third game picture and the instructions respectively corresponding to the next frame of game picture of the third game picture to the second game picture, the object state of the virtual object included in the second game picture.

In a possible implementation, the deletion module is further configured to delete the third state sets corresponding to the reference game pictures with a frame number greater than the second value, and delete the instructions corresponding to the game pictures with a frame number not less than the second value.

In a possible implementation, the display module 1301 is further configured to display, in response to the trigger operation of the rollback function, first prompt information in the first game picture based on that the reference value being not less than the first value, the first prompt information being configured for indicating that rollback is not available.

In a possible implementation, the display module 1301 is further configured to display, in response to the trigger operation of the rollback function, second prompt information in the first game picture based on that the reference value being less than the first value, the second prompt information being configured for indicating that the second game picture is being obtained.

In a possible implementation, the first game picture further includes a rollback control; and
the apparatus further includes:
a determining module, configured to determine triggering of the rollback function in response to a trigger operation for the rollback control.

In the apparatus, when the rollback function is triggered, the second game picture is displayed. The game state of the virtual object located in the virtual environment and included in the second game picture is the historical state, to control the virtual object to replay the game starting from the historical state. According to the method, when the player is accidentally hit in the first game picture, or triggers an incorrect operation in the first game picture, the player may use the rollback function to roll back to the second game picture prior to the first game picture, to continue the game with the object state in the second game picture, allowing the player a chance to restart, making the operation control manners for the game by the player more diversified, thereby improving the flexibility of operation control for the game by the player, and improving the gaming experience of the player to some extent.

When the apparatus provided above implements the functions of the apparatus, only division of the foregoing function modules is used as an example for description. During actual application, the foregoing functions may be allocated to and completed by different function modules according to requirements. That is, an internal structure of the device is divided into different function modules, to complete all or some of the functions described above. In addition, the apparatus provided in the foregoing embodiment belongs to the same idea as the method embodiments. For a specific implementation process thereof, refer to the method embodiments. Details are not described herein again.

FIG. 14 is a structural block diagram of a terminal device 1400 according to an exemplary embodiment of this application. The terminal device 1400 may be a portable mobile terminal, for example, a smartphone, a tablet computer, a moving picture experts group audio layer III (MP3) player, or a moving picture experts group audio layer IV (MP4) player, a notebook computer, or a desktop computer. The terminal device 1400 may also be referred to as another name such as user equipment, a portable terminal, a laptop terminal, or a desktop terminal.

Generally, the terminal device 1400 includes: a processor 1401 and a memory 1402.

The processor 1401 may include one or more processing cores, for example, may be a 4-core processor or an 8-core processor. The processor 1401 may be implemented in at least one hardware form of a digital signal processor (DSP), a field programmable gate array (FPGA), or a programmable logic array (PLA). The processor 1401 may alternatively include a main processor and a coprocessor. The main processor is a processor for processing data in a wake-up state, also referred to as a central processing unit (CPU). The coprocessor is a low-power processor configured to process the data in a standby state. In some embodiments, the processor 1401 may be integrated with a graphics processing unit (GPU). The GPU is configured to render and draw content that needs to be displayed on a display screen. In some embodiments, the processor 1401 may further include an artificial intelligence (AI) processor. The AI processor is configured to process computing operations related to machine learning.

The memory 1402 may include one or more computer-readable storage media. The computer-readable storage medium may be non-transient. The memory 1402 may further include a high-speed random memory and a nonvolatile memory, for example, one or more disk storage devices and flash memory storage devices. In some embodiments, the non-transient computer-readable storage medium in the memory 1402 is configured to store at least one instruction. The at least one instruction is configured to be executed by the processor 1401 to implement the operation control method provided in the method embodiments of this application.

In some embodiments, the terminal device 1400 may further include: a peripheral device interface 1403 and at least one peripheral device. The processor 1401, the memory 1402, and the peripheral device interface 1403 may be connected by using a bus or a signal cable. Each peripheral device may be connected to the peripheral device interface 1403 by using a bus, a signal cable, or a circuit board. Specifically, the peripheral device includes: at least one of a radio frequency circuit 1404, a display screen 1405, a camera assembly 1406, an audio circuit 1407, or a power supply 1409.

The peripheral device interface 1403 may be configured to connect at least one input/output (I/O)-related peripheral device to the processor 1401 and the memory 1402.

The radio frequency circuit 1404 is configured to receive and transmit a radio frequency (RF) signal, also referred to as an electromagnetic signal.

The display screen 1405 is configured to display a user interface (UI).

The camera assembly 1406 is configured to collect an image or a video.

The audio circuit 1407 may include a microphone and a speaker.

The power supply 1409 is configured to supply power to components in the terminal device 1400.

In some embodiments, the terminal device 1400 further includes one or more sensors 1410. The one or more sensors 1410 include, but are not limited to: an acceleration sensor 1411, a gyroscope sensor 1412, a pressure sensor 1413, an optical sensor 1415, and a proximity sensor 1416.

A person skilled in the art may understand that the structure shown in FIG. 14 does not constitute a limitation to the terminal device 1400, and the terminal may include more components or fewer components than those shown in the figure, or some components may be combined, or a different component deployment may be used.

FIG. 15 is a schematic structural diagram of a server according to an embodiment of this application. A server 1500 may vary greatly because a configuration or performance varies, and may include one or more central processing units (CPUs) 1501 and one or more memories 1502. The one or more memories 1502 has at least one piece of program code stored therein, and the at least one piece of program code is loaded and executed by the one or more processors 1501 to implement the operation control methods provided in the foregoing various method embodiments. Certainly, the server 1500 may further have components such as a wired or wireless network interface, a keyboard, an input/output interface for input and output. The server 1500 may further include other components configured to implement device functions. Details are not described herein again.

In an exemplary embodiment, a non-transitory computer-readable storage medium is further provided. The storage medium has a computer program stored therein, and the computer program is loaded and executed by a processor to cause a computer to implement any one of the foregoing operation control methods.

In some embodiments, the nonvolatile computer-readable storage medium may be a read-only memory (ROM), a random access memory (RAM), a compact disc read-only memory (CD-ROM), a magnetic tape, a floppy disk, an optical data storage device, and the like.

In an exemplary embodiment, a computer program product is further provided. The computer program product has a computer program stored therein. The computer program is loaded and executed by a processor to cause a computer to implement any one of the foregoing operation control methods.

Information (including, but not limited to, user equipment information, user personal information, and the like), data (including, but not limited to, data for analysis, stored data, displayed data, and the like), and signals in this application are all authorized by users or fully authorized by all parties, and collection, use, and processing of related data need to comply with relevant laws, regulations, and standards of relevant countries and regions. For example, the game pictures involved in this application are obtained with full authorization.

The term “plurality of” mentioned in the specification means two or more. The term “and/or” describing an association relationship between associated objects represents that there can be three relationships. For example, A and/or B can represent: Only A exists, both A and B exist, and only B exists. The character “/” generally indicates an “or” relationship between the associated objects.

The sequence numbers of the foregoing embodiments of this application are merely for illustrative purposes, and do not represent the preference of the embodiments.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. The foregoing descriptions are merely exemplary embodiments of this application, but are not intended to limit this application. Any modification, equivalent replacement, or improvement made within the principle of this application shall fall within the protection scope of this application.

What is claimed is:

1. An operation control method performed by a computer device, the method comprising:
displaying a first game picture, the first game picture including a virtual object located in a virtual environment and corresponding to a first state of a game;
controlling the virtual object to play the game in the virtual environment from the first state to a second state;
in response to a trigger operation of a rollback function, controlling the game to roll back a game state of the virtual object in the virtual environment from the second state to a historical state corresponding to a second game picture of the game; and
controlling the virtual object to replay the game starting from the historical state.

2. The method according to claim 1, wherein the controlling the game to roll back a game state of the virtual object in the virtual environment from the second state to a historical state corresponding to a second game picture of the game comprises:
determining a reference value according to a frame rate of the game and a reference duration in response to the trigger operation of the rollback function, the reference duration being a duration corresponding to the rollback function, and the reference value being a number of picture frames requiring rollback;
determining, based on the reference value being less than a first value, a second value according to the first value and the reference value, the first value being a frame number corresponding to the first game picture in the game, and the second value being a frame number corresponding to the second game picture in the game;
obtaining the second game picture according to the second value; and
displaying the second game picture.

3. The method according to claim 2, wherein the obtaining the second game picture according to the second value comprises:
obtaining, according to the second value, an object state of the virtual object comprised in the second game picture; and
obtaining the second game picture according to the object state of the virtual object comprised in the second game picture.

4. The method according to claim 3, wherein the obtaining, according to the second value, an object state of the virtual object comprised in the second game picture comprises:
determining a first state set corresponding to the second value; and
determining an object state of the virtual object comprised in the determined first state set as the object state of the virtual object comprised in the second game picture.

5. The method according to claim 3, wherein the obtaining, according to the second value, an object state of the virtual object comprised in the second game picture comprises:
determining instructions respectively corresponding to the second game picture from instructions corresponding to frames of game pictures according to the second value; and
obtaining, according to the instructions respectively corresponding to the second game picture, the object state of the virtual object comprised in the second game picture.

6. The method according to claim 3, wherein the obtaining, according to the second value, an object state of the virtual object comprised in the second game picture comprises:
determining, based on the second value and a third state set corresponding to the second game picture, the object state of the virtual object comprised in the second game picture.

7. The method according to claim 3, wherein the obtaining, according to the second value, an object state of the virtual object comprised in the second game picture comprises:
determining a third state set corresponding to a third game picture based on the second value not satisfying a preset frame number requirement and the second value, the third game picture being a reference game picture with a maximum frame number among reference game pictures whose corresponding frame numbers being less than the second value;
determining instructions respectively corresponding to the second game picture; and
obtaining, according to the third state set corresponding to the third game picture and the instructions respectively corresponding to the second game picture, the object state of the virtual object comprised in the second game picture.

8. The method according to claim 2, further comprising:
displaying, in response to the trigger operation of the rollback function, first prompt information in the first game picture based on the reference value being not less than the first value, the first prompt information being configured for indicating that rollback is not available.

9. The method according to claim 2, further comprising:
displaying, in response to the trigger operation of the rollback function, second prompt information in the first game picture based on the reference value being less than the first value, the second prompt information being configured for indicating that the second game picture is being obtained.

10. A computer device comprising a processor and a memory, the memory having a computer program stored therein, the computer program, when loaded and executed by the processor, causing the computer device to implement an operation control method including:
displaying a first game picture, the first game picture including a virtual object located in a virtual environment and corresponding to a first state of a game;
controlling the virtual object to play the game in the virtual environment from the first state to a second state;
in response to a trigger operation of a rollback function, controlling the game to roll back a game state of the virtual object in the virtual environment from the second state to a historical state corresponding to a second game picture of the game; and
controlling the virtual object to replay the game starting from the historical state.

11. The computer device according to claim 10, wherein the controlling the game to roll back a game state of the virtual object in the virtual environment from the second state to a historical state corresponding to a second game picture of the game comprises:
determining a reference value according to a frame rate of the game and a reference duration in response to the trigger operation of the rollback function, the reference duration being a duration corresponding to the rollback function, and the reference value being a number of picture frames requiring rollback;
determining, based on the reference value being less than a first value, a second value according to the first value and the reference value, the first value being a frame number corresponding to the first game picture in the game, and the second value being a frame number corresponding to the second game picture in the game;
obtaining the second game picture according to the second value; and
displaying the second game picture.

12. The computer device according to claim 10, wherein the obtaining the second game picture according to the second value comprises:
obtaining, according to the second value, an object state of the virtual object comprised in the second game picture; and
obtaining the second game picture according to the object state of the virtual object comprised in the second game picture.

13. The computer device according to claim 12, wherein the obtaining, according to the second value, an object state of the virtual object comprised in the second game picture comprises:
determining a first state set corresponding to the second value; and
determining an object state of the virtual object comprised in the determined first state set as the object state of the virtual object comprised in the second game picture.

14. The computer device according to claim 12, wherein the obtaining, according to the second value, an object state of the virtual object comprised in the second game picture comprises:
determining instructions respectively corresponding to the second game picture from instructions corresponding to frames of game pictures according to the second value; and
obtaining, according to the instructions respectively corresponding to the second game picture, the object state of the virtual object comprised in the second game picture.

15. The computer device according to claim 12, wherein the obtaining, according to the second value, an object state of the virtual object comprised in the second game picture comprises:
determining, based on the second value and a third state set corresponding to the second game picture, the object state of the virtual object comprised in the second game picture.

16. The computer device according to claim 12, wherein the obtaining, according to the second value, an object state of the virtual object comprised in the second game picture comprises:
determining a third state set corresponding to a third game picture based on the second value not satisfying a preset frame number requirement and the second value, the third game picture being a reference game picture with a maximum frame number among reference game pictures whose corresponding frame numbers being less than the second value;
determining instructions respectively corresponding to the second game picture; and
obtaining, according to the third state set corresponding to the third game picture and the instructions respectively corresponding to the second game picture, the object state of the virtual object comprised in the second game picture.

17. The computer device according to claim 11, wherein the method further comprises:
displaying, in response to the trigger operation of the rollback function, first prompt information in the first game picture based on the reference value being not less than the first value, the first prompt information being configured for indicating that rollback is not available.

18. The computer device according to claim 11, wherein the method further comprises:
displaying, in response to the trigger operation of the rollback function, second prompt information in the first game picture based on the reference value being less than the first value, the second prompt information being configured for indicating that the second game picture is being obtained.

19. A non-transitory computer-readable storage medium, having a computer program stored therein, the computer program, when loaded and executed by a processor of a computer device, causing the computer device to implement an operation control method including:
displaying a first game picture, the first game picture including a virtual object located in a virtual environment and corresponding to a first state of a game;
controlling the virtual object to play the game in the virtual environment from the first state to a second state;
in response to a trigger operation of a rollback function, controlling the game to roll back a game state of the virtual object in the virtual environment from the second state to a historical state corresponding to a second game picture of the game; and
controlling the virtual object to replay the game starting from the historical state.

20. The non-transitory computer-readable storage medium according to claim 19, wherein the controlling the game to roll back a game state of the virtual object in the virtual environment from the second state to a historical state corresponding to a second game picture of the game comprises:
determining a reference value according to a frame rate of the game and a reference duration in response to the trigger operation of the rollback function, the reference duration being a duration corresponding to the rollback function, and the reference value being a number of picture frames requiring rollback;
determining, based on the reference value being less than a first value, a second value according to the first value and the reference value, the first value being a frame number corresponding to the first game picture in the game, and the second value being a frame number corresponding to the second game picture in the game;
obtaining the second game picture according to the second value; and
displaying the second game picture.
